(19) United States
(12) Patent Application Publication
(10) Pub. No.: US 2025/0328369 A1
(43) Pub. Date: Oct. 23, 2025

(54) Agnostic Joint Automation Executable

(71) Applicants: Joseph Slater, Colonial Beach, VA (US); Nathan W. Hoy, King George, VA (US); Aaron L. Pierson, King George, VA (US); Deivy L. Vega-Mena, Fredericksburg, VA (US); Michael Benos, Alexandria, VA (US)

(72) Inventors: Joseph Slater, Colonial Beach, VA (US); Nathan W. Hoy, King George, VA (US); Aaron L. Pierson, King George, VA (US); Deivy L. Vega-Mena, Fredericksburg, VA (US); Michael Benos, Alexandria, VA (US)

(73) Assignee: United States of America, as represented by the Secretary of the Navy, Arlington, VA (US)

(21) Appl. No.: 18/596,710

(22) Filed: Mar. 6, 2024

(51) Int. Cl. G06F 9/455

(52) U.S. Cl. CPC G06F 9/45558; G06F 2009/4557; G06F 2009/45587; G06F 2009/45595

(57) ABSTRACT

A method for automating the deployment, configuration, and security of virtualized tactical systems. The method comprises determining at least one host hardware architecture, installing hypervisors on each host within a system based on the host hardware architecture, deploying and configuring virtual machines essential for the operation of a virtualized tactical system, configuring a virtual networking, configuring virtual management, and installing tactical virtual machines, and applying security guidelines and configurations to ensure the system's integrity.

### STATEMENT OF GOVERNMENT INTEREST

The invention described was made in the performance of official duties by one or more employees of the Department of the Navy, and thus, the invention herein may be manufactured, used or licensed by or for the Government of the United States of America for governmental purposes without the payment of any royalties thereon or therefor.

### BACKGROUND

The disclosure relates generally to the field of virtualized system deployment and security, specifically to an automated system designed to deploy, configure, and secure virtualized tactical environments efficiently.

### SUMMARY

### Purpose

The purpose of the Agnostic Joint Automation Executable (AJAX) is to deploy configure and secure a virtualized tactical machine such as the Aegis combat system.

### Virtualization

Virtualization is a technology that allows the creation of IT services using resources traditionally bound to hardware. It allows the use of a physical machine's full capacity by distributing its capabilities among many users or environments.” Traditionally, legacy systems are constructed on a one purpose per one server model. In this model, individual purposes rarely consume the entirety of a server's resource capacity. For example, if a legacy environment has four servers, and each server's purpose only utilizes 20% of the server's resources, 80% of the total resources are not being utilized. With virtualization, the server's resources can be logically separated into four separate instances and reduce the server count to a single server utilizing 80% of its resource capacity. These logical instances are referred to as Virtual Machines (VMs). Separating these purposes into VMs frees three of the servers for other purposes, and/or allows them to be removed entirely resulting in a reduction in both cost and footprint.

Virtual machines (VM) are a virtual computer system is a tightly isolated software container with an operating system and application inside.” It is important to note that each VM's resources are entirely autonomous of other virtual machines despite residing on the same physical hardware server. These physical servers can distribute their resources to multiple VMs by employing a small piece of software called a hypervisor. Physical servers supporting virtual machines are referred to as “hosts”, because they are “hosting” virtual machines on their physical hardware.

### Aegis Combat System

The Department of the Navy's primary surface tactical system is the Aegis combat system. The tactical system refers to the legacy or virtualized components that make up the Aegis combat system. E.g. “Deploying the tactical system” implies installing or instantiating the components of a legacy or virtualized Aegis combat system in a physical or virtual environment.

The Aegis combat system has dozens of individual components that work together creating the services needed by the United States Navy. In a virtualized environment, these individual components are VMs running on hosts utilizing a hypervisor. One example is a Virtual Test Environment (VTE), which refers to a virtualized instance of the Aegis combat system running on a non-legacy hardware suite. V-Twin is another example of a virtualized environment that hosts the Aegis combat system. The primary difference between these two systems is the hardware hosting the VMs, as the tactical VMs have little to no difference between builds. Many objects within AJAX are utilized for both VTEs and V-Twins, in such cases the term virtual tactical systems will be used.

### Purpose

The cost benefits, rapid update capability and accessibility of VTEs and V-Twins has led to rapid proliferation and high demand across the United States. These virtual environments require a highly specific and unique skill set. This skill set is a mixture of expert knowledge of the tactical system and an expert level of virtualization experience. Due to this uniqueness and specificity, individuals possessing the capability to deploy a virtualized tactical system are rare, and highly sought after. Furthermore, training and retaining individuals to possess these capabilities, is a lengthy process often taking years for candidates to reach proficient levels. That is why present deployment and implementation strategies for virtual tactical systems struggle to meet the high technical knowledge and timeline requirements associated with these systems. Automating the deployment and the configuration of these systems is the only current viable method to address these issues. However, current strategies are performed manually and are, therefore, error prone. This is attributed to the aforementioned personnel requirements and general human error when performing thousands of configuration options. The purpose of AJAX is to empower individuals via automation to perform the specific, complex tasks of deploying a tactical system in a virtualized environment in a timely, error resistant manner.

### BACKGROUND

There are a few key terms and assumptions to be made prior to detailing the current deployment strategies for virtualized tactical systems. These include:
1. The rack is cabled correctly;
2. The time server for the system is configured and running;
3. There is a configured network switch; and
4. The Baseboard Management Controller (BMC) IPs are set if present.

Currently, the overwhelming majority of virtualized tactical systems run as VMware systems. VMware is the leading virtualization technology provider and a leader in multi-cloud services. VMware's virtualization platform is vSphere, which has two primary components, VMware ESXi and vCenter. VMware uses VMware ESXi (referred to as ESXi) as its hypervisor, which runs directly on the system hardware without an operating system. vCenter is a data center server application that provides centralized management of vSphere virtual infrastructure.

### Installing ESXi

Manual installation of ESXi requires a monitor, keyboard, and an ESXi installation disk. The installation process involves inserting the installation disk, then connecting the display and keyboard to each physical server. During installation, there are numerous configuration options that need to be performed to ensure the system functions as intended. This method is tedious and time consuming, as one is generally only able to perform installation on one ESXi host at a time. Installing and reconfiguring ESXi requires two reboots of the server, which, when performed on individual hosts greatly increases installation times. Virtualized tactical systems can have over 20 hosts which would all require installation and configuration using the aforementioned processes.

Installing vCenter

Manual installation of vCenter is primarily done through use of the Graphical User Interface (GUI) and is run through an installation wizard. Installation of vCenter requires some general information on numerous aspects of the vCenter Server Appliance. A full list of the required information is detailed in the VMware vCenter Installation Procedure. This process is not overly difficult, but does require a baseline familiarity with management appliances and a functional knowledge of VMware products.

### Configuring the Virtualized Environment

This portion of deploying the virtualized tactical system is arguably the most complex as it requires detailed knowledge of both tactical and virtualization technologies.

After deploying vCenter, one must create the datacenter which contains all of the objects for a fully-functional virtual environment. Within the datacenter host clusters are created. A cluster is simply a group of hosts, and the cluster manages all of the hosts' resources within that cluster. Once the clusters are created, the ESXi hosts themselves must be added to the correct cluster.

Once the hosts are added to the datacenter in the appropriate clusters, the virtual networking must be configured. The appropriate host Network Interface Card (NIC) must be selected and added to the host for the workload networks. The workload networks are networks that the tactical system utilizes to communicate. After the appropriate NIC has been selected and assigned to the host, the virtual port-groups must be configured and assigned on every host. This involves configuring the correct name, security settings, and VLAN ID for every port-group utilized by the tactical VMs residing on that host. Large numbers of configuration changes are attributed with higher error rates and this procedure is no exception. Due to the large number of configuration changes within this portion of the procedure, through incorrect assignment or omission, is subject to a high amount of human error. Manually creating 6-10 port groups with 3-10 configuration options across 10-25 ESXi hosts results in over 900 configuration actions on average. Manually applying these configuration options is a time-consuming endeavor. The repetitive nature of the tasks contributes to fatigue, which can lead to costly mistakes. If a network is not correctly applied on any given host, a tactical VM may not have access to the network, and therefore, would be unable to function. Errors in this configuration set can be very difficult to troubleshoot, leading to greater delays in the deployment of the tactical system.

### Deploying the Tactical System

Deploying the tactical system can be done in a variety of ways, but the approved, best practice method is to use Open Virtualization Appliance (OVA) files. An OVA is a single file containing all the information to deploy a preconfigured VM. Current methods employ VMware's ovftool, which is a command-line utility that allows importation or exportation of OVF or OVA packages to the virtual environment. VMware's ovftool requires exact configuration of specific settings on the machine it is operating from to function properly. An example is not configuring the Full Qualified Domain Name (FQDN) of the host when deploying the ova package. If this is not done correctly, ovftool will go through the entire deployment process of the package and fail in the last 3% of the deployment. This is a massive cost in time as certain tactical Network Attached Storage (NAS) VMs, (essentially the brain of the tactical system) can take over 4 hours to deploy. It must also be mentioned that there is often wasted man hours associated with human limitations. Manual instantiation often involves starting the deployment of a single VM and the individual then focusing on another task while the deployment is taking place. If the VM deployment completes, the individual may or may not be present to start the next VM's deployment.

Tactical VMs must be deployed on the correct hosts to satisfy storage and networking requirements that are unique to each tactical build. The VM NICs must be configured with exact requirements on Media Access Control (MAC) addresses and virtual port-groups to operate correctly. These actions require an advanced knowledge of the technical requirements associated with the Aegis Combat System and differ between iterations of the tactical system. Even those possessing the required knowledge and skills are prone to making errors in initial deployment due to the large amount of configuration changes required and the manual nature of the deployment.

### Securing the System

Security Technical Implementation Guidelines (STIGs) are published by the Defense Information Systems Agency (DISA) and are required to be implemented on networks, servers, and computers. STIGs are guides to verify or correct known or potential cybersecurity vulnerabilities. There are currently 63 VMware recommended STIGs for ESXi version 7 and 59 recommended for vCenter. These numbers are subject to change pending the official publication of the DISA STIGs for these versions, but it is considered best practice to employ the VMware recommendations until such time. Each STIG must be checked and have its status and correction recorded and submitted for review. Currently this process is manual and requires detailed technical and security knowledge. This process involves manually applying the verifications and corrections for each STIG on every ESXi host and vCenter instance. On a 20-host system this involves manually checking, potentially correcting, and recording at least 1,300 different security settings. If we assume an average of six port-groups per host this number grows to 1,600. This process is mentally strenuous due to the large number of checks, the level of knowledge required, and the repetitiveness of the task. Incorrect security settings, missed checks, and improper recording of STIG application is essentially guaranteed and requires heavy review and reapplication of STIGs to combat errors. This process requires a heavy investment of time, generally requiring 160 man-hours to complete assuming there are no errors.

### Description and Operation

AJAX is an automation tool designed to deploy, configure, and secure virtualized systems with tactical environments regardless of the physical hardware. Different hardware sets and licensing levels require different methods of configuration and deployment. AJAX can discover the properties of the environment it is attached to and deploys the infrastructure based off of the destination systems unique requirements. i.e Dell specific ESXi installation vs generic ESXi installation. Operater controlled configuration methods also allow for different numbers and overall infrastructure configurations of Navy Virtual environments (aforementioned vTwin and VTE racks full or half-rack variants). AJAX then performs CM configuration of the virtualized Aegis Weapon System and secures ESXi hosts in accordance with DISA STIG guidelines.

### Hypervisor Deployment (Francis)

The first task of AJAX is to install the hypervisor on all hosts within the target system. This lays the foundation upon which the entire virtualized tactical system will be built. AJAX has the flexibility to accomplish this on a variety of hardware manufacturers and levels of licensing. First a probe of the Baseboard Management Controller (BMC) via the REDFISH standardized Application Programming Interface (API) will take place. The outcome will determine the method AJAX uses to deploy the hypervisor. If the BMC has the capability to accept and utilize virtual media, then a customized Optical Disc Image (ISO) file is generated and mounted to the BMC. Then the server is instructed to boot from the virtual media on the next boot only, and the server is rebooted. If the BMC is not capable of utilizing virtual media due to licensing or limitations, AJAX will attempt to retrieve the Media Access Control (MAC) address of the first Ethernet Port. If this is successful, AJAX will use that MAC address to generate a Dynamic Host Configuration Protocol (DHCP) configuration file, a pxelinux configuration file, a customized ISO file. This combination of files, DHCP Container, and Hypertext Transfer Protocol (HTTP) container are used to Pre-Executable Environment (PXE) boot the server to the customized ISO which will install the hypervisor in a preconfigured manner. The last method AJAX possesses is to acquire the MAC addresses of the servers from the coreswitch's Address Resolution Protocol (ARP) table. For this method an open DHCP container will run to provide a pxelinux configuration that constantly reboots the server. The operator will be instructed to either boot or reboot all of the servers. Once the ARP table is populated with the required entries based off of their reported Ethernet ports, AJAX will ingest the MAC addresses and proceed with PXE booting the servers in the same manner as the last method discussed.

### Virtual Machine Deployment (Pegasus)

Once the hypervisors are all deployed, Virtual Machines can be deployed on them. The first virtual machine AJAX deploys is the Domain Name System (DNS). This is required to provide the DNS service to the system which is required by VMware to communicate with all hosts and vCenter. This is accomplished by utilizing PowerShell with VMware's PowerCLI module. Once DNS is deployed, vCenter is deployed utilizing VMware's VCSA-CLI-Installer. This command line installer is coupled with a JavaScript Object Notation (JSON) file that configures the vCenter virtual machine automatically. Lastly, Hashicorp's Terraform is used to complete the rest of the Virtual Machine Deployment as well as the Virtual Infrastructure Deployment. The order of operations for Terraform are as follows: deploy clusters to group servers of similar tasking (i.e. Management, Tactical, Simulation, etc.), place the ESXi hosts into their appropriate clusters, build virtual switches to separate workload from management, configure virtual switches to appropriately manage all workload traffic, deploy tactical Virtual Machines.

### Security: Operating the SAFE Tool

STIG Automation For ESXi (SAFE) is the security portion of AJAX. SAFE is a module within AJAX that is called after the virtualization and tactical deployments are completed. SAFE primarily uses PowerCLI which is a VMware developed module for PowerShell providing cmdlets for automating and managing numerous VMware products including vSphere. SAFE also utilizes Bash, ESXCLI, and REST API calls to verify and correct STIGs appropriately.

SAFE is developed modularly, that is, each STIG has a respective script, including one for correction and verification. This allows for a high degree of granularity when applying or correcting STIGs using SAFE. The user can choose whether to only verify the current state of the security check or to choose to apply the correction should a security violation (finding) be discovered. A verification script (FIG. S1) and a correction script (FIG. S2) are listed to display the differences between the two.

These individual scripts are dynamically added via the SAFE GUI and then are run sequentially. An example of this script can be seen in FIG. S1. Each script in SAFE will run against all ESXi hosts in the hostInfo.csv file before moving on to the next script. There are two different methods for choosing the ESXi hosts to run SAFE against. One, is choosing the hosts manually via the GUI. With this option when the GUI is launched, a script runs to poll the VCenter for all attached ESXi hosts and populates them in the GUI for user selection. When run manually (via command-line) SAFE will run against all hosts attached to the VCenter. In both options ESXi host FQDN are added to the hostInfo.csv file. The main difference being that the GUI allows editing the hostInfo.csv prior to running SAFE.

Each individual script is titled by the DISA STIG ControlID number and brief description of the STIGs purpose i.e. ESXI-70-000001_V_lockdownMode.ps1. Where “ESXI-70” denotes the STIG is for an ESXi host running version 7, “−000001” lists the ControlID, “_V_” states this script is a verification only script (an_C_would dentote verification and correction), and “lockdownMode fives a more human readable intent of the script, and “.ps1” is the file extension for a PowerShell script.

A report is generated for each VCenter and ESXi host respectively detailing the results of each STIG verification or correction. The generated report is in Comma Separated Value (CSV) format and includes DISA information about each STIG and the results from the SAFE run. Upon completion of the SAFE scripts a report is generated based on the FQDN of each host. Each report is date and time stamped at time of completion for identification between multiple SAFE runs. An example title of such a report would be 1655555_TAC01.domain.com_04212022.

### Advantages and New Features

AJAX provides a myriad of new advantages and features. One of the largest advantages of using AJAX is the reduction in man-hours required to deploy and secure a virtualized tactical system. Manual deployments of virtualized environments, based off current practices, take 80 man-hours to complete. Whereas, an AJAX tactical system deployment takes 4 man-hours, with faster times depending on transfer speed availability for tactical VMs. Manually applying and recording DISA STIGs on a virtualized tactical system takes 160 man-hours. Conversely, utilizing SAFE as a part of AJAX reduces the time to approximately 10 minutes. Deployments with AJAX results in a total secured deployment time of 4 hours and 10 minutes versus traditional deployment times of 240 man-hours. These automated deployment practices translate to a total time savings of 235 hours and 50 minutes.

As previously mentioned, the technical and tactical baseline knowledge requirement involved with deploying these systems is high. With AJAX, end users are simply able to choose their desired system configuration and security level, then deploy a functional virtualized tactical system. This is an extraordinary advantage over traditional methods that involve qualified personnel traveling to remote sites for installations. Additionally, future issues with the system that would normally garner another travel response, can be resolved by simply redeploying the system to resolve the issue. Not only are these new features more cost effective, they also result in the end user requirements being fulfilled sooner.

There is currently a requirement to verify STIGs and scan for vulnerabilities on all virtualized tactical systems quarterly. There is no tool currently capable of scanning for DISA defined vulnerabilities on ESXi hosts other than SAFE. This process must be done manually and by qualified personnel with direct access to the system. With SAFE, this requirement can be met in a fraction of the time by the local system administrators. The SAFE generated report can then be submitted to the security team responsible for reviewing the systems security posture.

Having the deployment of these systems automated provides an exceptionally error resistant deployment, whereas a manual deployment is more error prone. This is due to the sheer number of configuration options throughout the implementation and securing of the virtualized system. By automating this process, AJAX removes fatigue, lack of knowledge, and general operator error from the deployment process. When issues do arise, personnel can rule out configuration errors attributed to manual deployments and are able to resolve the problems more quickly. Deployments with AJAX are nearly error free and streamline the troubleshooting process when system errors do arise.

In one embodiment, a method for automating the deployment, configuration, and security of virtualized tactical systems is disclosed. The method includes determining at least one host hardware architecture, installing hypervisors on each host within a system based on the host hardware architecture, deploying and configuring virtual machines essential for the operation of a virtualized tactical system, configuring a virtual networking, configuring virtual management, and installing tactical virtual machines, applying security guidelines and configurations to ensure the system's integrity, and deploying the virtualized tactical machines.

In some embodiment, the method discloses that the hypervisor deployment methodology is adaptable to various hardware manufacturers and licensing levels. In some embodiments, when the method detects a hardware architecture and license that allows the hypervisor to be installed using Application Programming Interface (API) mounted customized Optical Disc Images (ISO) and installing the hypervisor using Application Programming Interface (API) mounted customized Optical Disc Images (ISO). In some embodiments, when the method detects a hardware architecture and license that allows the hypervisor to be installed by pulling information from the host via an Application Programming Interface (API) to allow network booting of an customized installation Optical Disc Images (ISO) and installing the hypervisor by pulling information from the host via an Application Programming Interface (API) to allow network booting of an customized installation Optical Disc Images (ISO). In some embodiments, when the method detects a hardware architecture and license that allows the hypervisor to be installed by pulling information from a network switch or user input to allow network booting of a customized installation Optical Disc Images (ISO) and installing the hypervisor by pulling information from a network switch or user input to allow network booting of an customized installation Optical Disc Images (ISO). In some embodiments, the applying security guidelines and configurations further comprises verification of security guidelines across the system. In some embodiments, the applying security guidelines and configurations further comprises application of security guidelines across the system. In some embodiments, the applying security guidelines and configurations further comprises generating reports that will be used to certify the security posture of a virtualized tactical system. In some embodiments, the tactical virtual machine is a combat system capable of and guiding weapons to destroy a target. In some embodiments, wherein configuring a virtual network, configuring virtual management, and installing tactical virtual machines, is unique to each instance of the combat system to include a plurality of distinct virtual networks to ensure operability. In some embodiments, the combat systems further comprises at least twenty (20) distinct virtual networks. In some embodiments, configuring a virtual networking, configuring virtual management, and installing tactical virtual machines, is unique to each Virtual Tactical system. In some embodiments, deploying and configuring virtual machines essential for the operation of a virtualized tactical system, is unique to all tactical systems and wherein the configuration of virtual machines includes hostnames, MAC addresses, Internet Protocol Addresses, and Networking uplinks.

### BRIEF DESCRIPTION OF THE DRAWINGS

These and various other features and aspects of various exemplary embodiments will be readily understood with reference to the following detailed description taken in conjunction with the accompanying drawings, in which like or similar numbers are used throughout, and in which:

FIG. 1 is an overview of the disclosed method; and

FIGS. 2A-D are a detailed view of FIG. 1.

### DETAILED DESCRIPTION

The disclosed methods and systems below may be described generally, as well as in terms of specific examples and/or specific embodiments. For instances where references are made to detailed examples and/or embodiments, it should be appreciated that any of the underlying principles described are not to be limited to a single embodiment but may be expanded for use with any of the other methods and systems described herein as will be understood by one of ordinary skill in the art unless otherwise stated specifically.

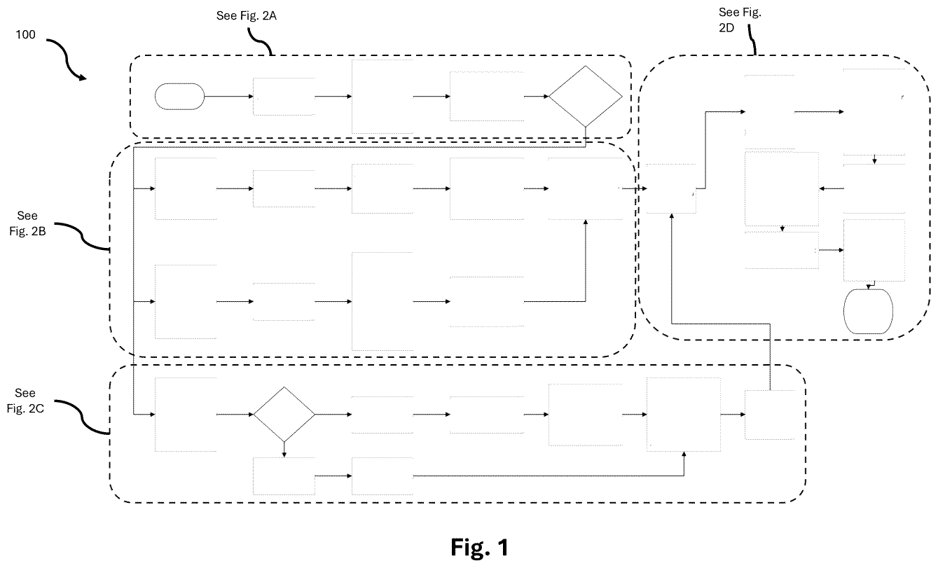

FIG. 1 shows an overview of the disclosed method 100.

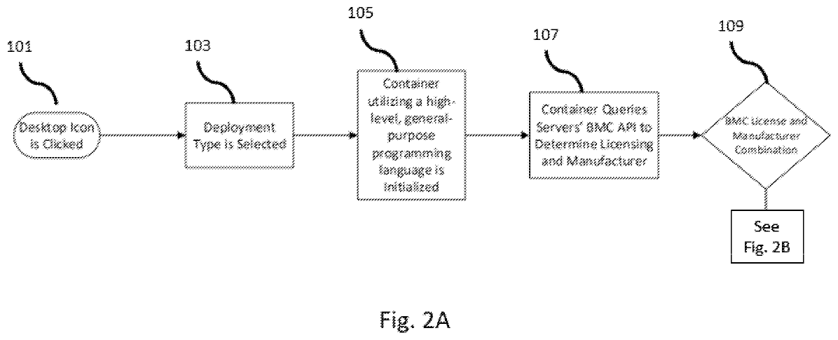

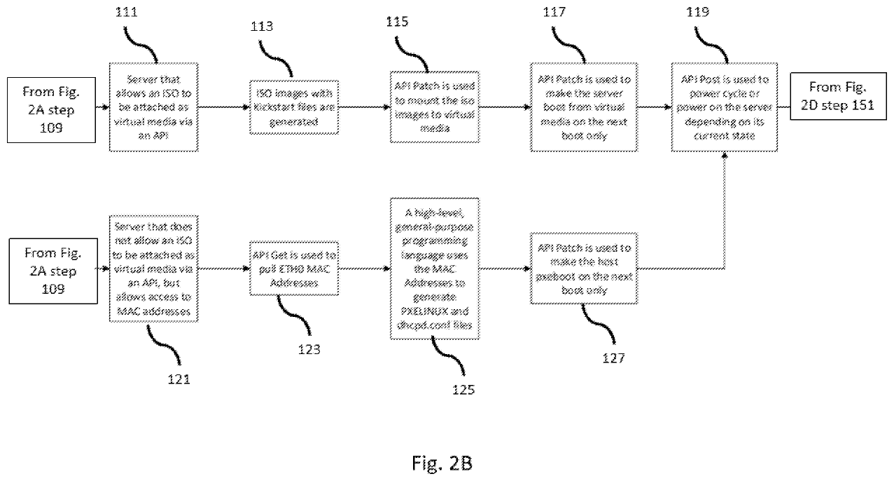

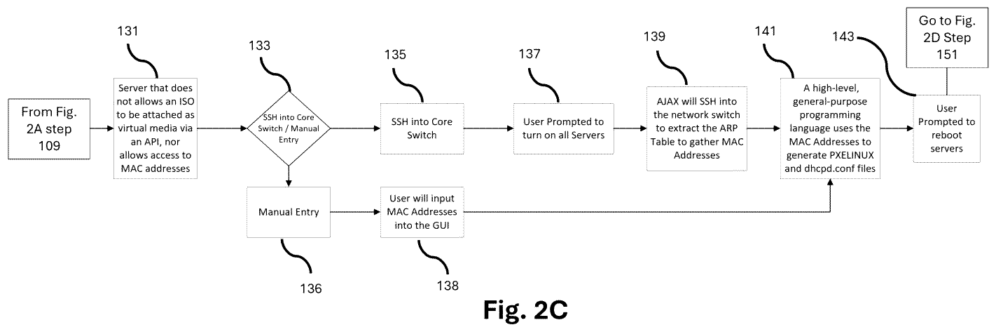

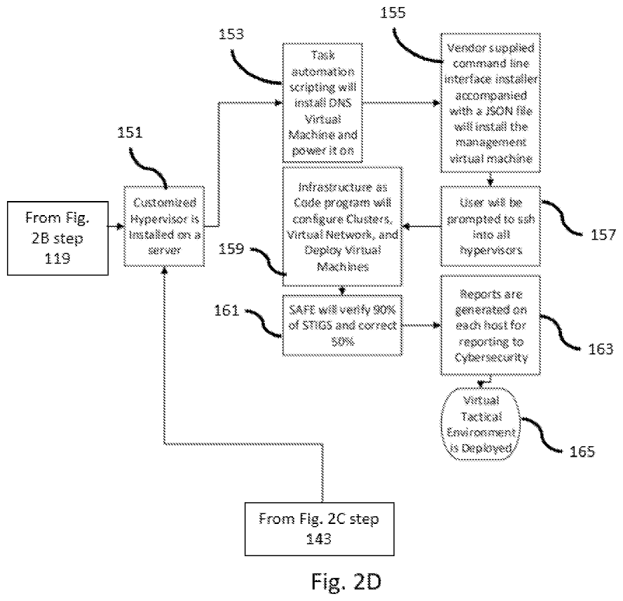

FIG. 2A shows the initiation of the disclosed method. In certain embodiments, In step 101, the deployment is initiated using a desktop icon. In step 103, the deployment type is selected. In step 105, a container utilizing a high-level, general-purpose programming language is initialized. In some embodiments, the general-purpose programming language is python. In step 107, the container queries Servers' BMC API to determine the appropriate licensing and manufacturer of the host. In some embodiments, this is accomplished using the REDFISH standardized Application Programming Interface (API). In step 109, the method determines the BMC license and manufacture combination is used to determine the requirements of the server deployment required. The different types 111, 1XX, 1XX will be discussed in order.

As shown in FIG. 2B, the method continues to step 111, when the method, at step 109, determines a server, such as a Dell, Supermicro with Data Center Management Suite (DCMS) license, or a Cisco, that allows an Identical Storage Image of Optical Media (ISO) to be attached as virtual media vie an API. In step 113, the ISO images with Kickstart files are generated. In step 115, an API patch is used to mount the ISO images to virtual media. In step 117, an API patch is used to make the server boot from virtual media on the next boot only. In step 119, an API post is used to power cycle or power on the server depending on its current state.

The method continues to step 121, when the method, at step 109, determines that the server, such as a Supermicro with Out of Band (OOB) BMC license, does not allow an ISO to be attached as virtual media via an API, but does allow access to MAC addresses. In step 123, the API Get request is used to pull ETHO MAC addresses. In step 125, a high-level general-purpose programming language uses the MAC addresses to generate PXELINUX and “dhcpd.conf” files. In step 127, an API patch is used to make the hose pxeboot on the next boot only. In step 119, an API post is used to power cycle or power on the server depending on its current state.

The method continues to step 131, when the method, at step 109, determines that the server, such as a Supermicro with no BMC license, does not allow an ISO to be attached as virtual media via an API, nor allows access to MAC addresses. In step 133, the method determines whether the Secure Shell or Secure Socket Shell (SSH) requires a Core Switch, step 135, or manual entry, step 136. If at step 133 determines that a Core Switch is required, the method turns to step 135 and, in step 137, the user is prompted to turn on all servers. In step 139, AJAX will SSH into the network switch to extract the Address Resolution Protocol (ARP) Table to gather Media Access Control (MAC) addresses. In step 141, a high-level general-purpose programming language uses the MAC addresses to generate PXELINUX and “dhcpd.conf” files. In step 143, the user is prompted to reboot the servers.

If at step 133 determines that manual entry is required, the method turns to step 136 and, in step 138, the user is prompted to input MAC addresses into the Graphical User Interface (GUI). In step 141, a high-level general-purpose programming language uses the MAC addresses to generate PXELINUX and “dhcpd.conf” files. In step 143, the user is prompted to reboot the servers. Regardless of which server type is detected in step 109, the method continues at step 151. In step 151, the customized hypervisor is installed on the server. In step 153, task automation scripting will install DNS virtual machine and power it on. In step 155, the vendor supplied command line interface installer accompanied with a JSON file will install the management virtual machine. In step 157, the user will be prompted to ssh into all hypervisors. In step 159, the infrastructure as code program will configure clusters, virtual network, and deploy virtual machines. In step 161, SAFE will verify 90% of STIGS and correct 50%. In step 163, reports are generated on each host for reporting to cybersecurity. In step 165, the virtual tactical environment is deployed.

While certain features of the embodiments of the invention have been illustrated as described herein, many modifications, substitutions, changes and equivalents will now occur to those skilled in the art. It is, therefore, to be understood that the appended claims are intended to cover all such modifications and changes as fall within the true spirit of the embodiments.

What is claimed is:

1. A method for automating the deployment, configuration, and security of virtualized tactical systems, the method comprising:
determining at least one host hardware architecture;
installing hypervisors on each host within a system based on the host hardware architecture;
deploying and configuring virtual machines essential for the operation of a virtualized tactical system;
configuring a virtual networking, configuring virtual management, and installing tactical virtual machines;
applying security guidelines and configurations to ensure the system's integrity; and
deploying the virtualized tactical machines.

2. The method of claim 1, wherein the hypervisor deployment methodology is adaptable to various hardware manufacturers and licensing levels.

3. The method of claim 2, detecting a hardware architecture and license that allows the hypervisor to be installed using Application Programming Interface (API) mounted customized Optical Disc Images (ISO) and installing the hypervisor using Application Programming Interface (API) mounted customized Optical Disc Images (ISO).

4. The method of claim 2, detecting a hardware architecture and license that allows the hypervisor to be installed by pulling information from the host via an Application Programming Interface (API) to allow network booting of a customized installation Optical Disc Images (ISO) and installing the hypervisor by pulling information from the host via an Application Programming Interface (API) to allow network booting of a customized installation Optical Disc Images (ISO).

5. The method of claim 2, detecting a hardware architecture and license that allows the hypervisor to be installed by pulling information from a network switch or user input to allow network booting of a customized installation Optical Disc Images (ISO) and installing the hypervisor by pulling information from a network switch or user input to allow network booting of a customized installation Optical Disc Images (ISO).

6. The method of claim 1, wherein the applying security guidelines and configurations further comprises verification of security guidelines across the system.

7. The method of claim 1, wherein the applying security guidelines and configurations further comprises application of security guidelines across the system.

8. The method of claim 1, wherein the applying security guidelines and configurations further comprises generating reports that will be used to certify the security posture of a virtualized tactical system.

9. The method of claim 1, wherein the tactical virtual machine is a combat system capable of tracking and guiding weapons to destroy a target.

10. The method of claim 9, wherein configuring a virtual network, configuring virtual management, and installing tactical virtual machines, is unique to each instance of the combat system to include a plurality of distinct virtual networks to ensure operability.

11. The method of claim 10, wherein the combat systems further comprises at least twenty (20) distinct virtual networks.

12. The method of claim 1, wherein configuring a virtual networking, configuring virtual management, and installing tactical virtual machines, is unique to each Virtual Tactical system.

13. The method of claim 1, wherein deploying and configuring virtual machines essential for the operation of a virtualized tactical system, is unique to all tactical systems and wherein the configuration of virtual machines includes hostnames, MAC addresses, Internet Protocol Addresses, and Networking uplinks.
